(19) United States
(12) Patent Application Publication
(10) Pub. No.: US 2017/0283749 A1
(43) Pub. Date: Oct. 5, 2017

(54) WATER SOLUBLE POUCH

(71) Applicant: The Procter & Gamble Company, Cincinnati, OH (US)

(72) Inventors: Miguel BRANDT SANZ, Brussels (BE); Andrea GABRIELE, Brussels (BE)

(21) Appl. No.: 15/627,785

(22) Filed: Jun. 20, 2017

Related U.S. Application Data
(62) Division of application No. 14/668,200, filed on Mar. 25, 2015.
(60) Provisional application No. 61/972,670, filed on Mar. 31, 2014.

(51) Int. Cl. B65B 61/02; C11D 17/04

(52) U.S. Cl. CPC C11D 17/043; B65B 61/025; B65B 2230/02; C11D 17/044; B41M 1/30

(57) ABSTRACT

A water soluble pouch containing a substrate treatment agent, the water soluble pouch having printed characters, and a process for making the same.

### FIELD OF THE INVENTION

Water soluble pouches containing a substrate treatment agent.

### BACKGROUND OF THE INVENTION

Water soluble pouches for delivering substrate treatment agents, such as dishwashing detergents, laundry detergents, surface cleaning compositions, and laundry treatment compositions, are increasing in popularity globally. Typically, the consumer places the pouch in a compartment in the dishwashing machine or in the drum of a clothing washing machine or bucket of water, the pouch is exposed to water, and the pouch dissolves and releases the treatment agent.

The substrate treatment agent can be a solid or liquid. Some pouches have multiple compartments and liquids in each of the compartments. Some pouches have multiple compartments with one compartment containing a solid and another compartment containing a liquid. Individual compartments of multi-compartment pouches can have different dissolution rates, thereby providing for delivery of the substrate treatment agents within individual compartments at different times during the cycle of the wash.

Typically, marketers of pouches of substrate treatment agents sell a plurality of pouches within a single container. To promote ease of use and minimize waste, the pouches within a container are not individually packaged in secondary packages.

For many consumers, their highest focus on the products they choose is at the point of using the product in their home. This can be a critical time for marketers to communicate the benefits that can be achieved by using the product. It can also be a time when consumers are most receptive to receiving instructions from the marketer on how to use the product to obtain the maximum benefit from the product.

In absence of a secondary package, instructions to the consumer can be provided on the pouch itself. Since the pouch is designed to dissolve in use, the medium that carries the instructions needs to also dissolve in use. Since the pouch is water soluble, the instructions can be printed on the pouch or the precursor webs used to form the pouch.

Water soluble pouches typically have a complex three dimensional surface. Printing on such complex three dimensional surfaces can be challenging. Many printing technologies are suited to print on surfaces that have substantially flat or are at least flat in one dimension, for example height, and have a regular degree of curvature in another direction, such as a cylindrical container or a container having a simple curved face.

Unlike cylindrical containers and containers having a simple curved face, water soluble pouches typically have dome shaped faces. Further, water soluble pouches are typically deformable under pressures typically applied in printing operations in which the printing apparatus contacts the substrate being printed.

With these limitations in mind, there is a continuing unaddressed need for water soluble pouches having printing disposed thereon and processes for printing water soluble pouches.

### SUMMARY OF THE INVENTION

A water soluble pouch comprising: a water soluble first sheet comprising a first plurality of adjacent printed characters each having a font size within about 15% of each member of said first plurality of adjacent printed characters; and a water soluble second sheet joined to said water soluble first sheet to define a chamber containing a substrate treatment agent; wherein at least one of said water soluble first sheet and said water soluble second sheet is a plastically deformed sheet.

A process of making a water soluble pouch comprising the steps of: distortion printing a first plurality of adjacent printed characters on a water soluble first sheet; providing a water soluble second sheet; forming a compartment in one of said first sheet and said second sheet by plastic deformation; placing a substrate treatment agent in said compartment; and sealing said first sheet and said second sheet to one another to form an enclosed pouch having a chamber.

### BRIEF DESCRIPTION OF THE DRAWINGS

FIG. 1 is a water soluble pouch.

FIG. 2 is a cross section of a water soluble pouch.

FIG. 3 is an apparatus for making a water soluble pouch.

FIG. 4 a cross section of a mold for making a water soluble pouch.

FIG. 5 is a distortion printed web.

FIG. 6 is a top view of a pouch.

### DETAILED DESCRIPTION OF THE INVENTION

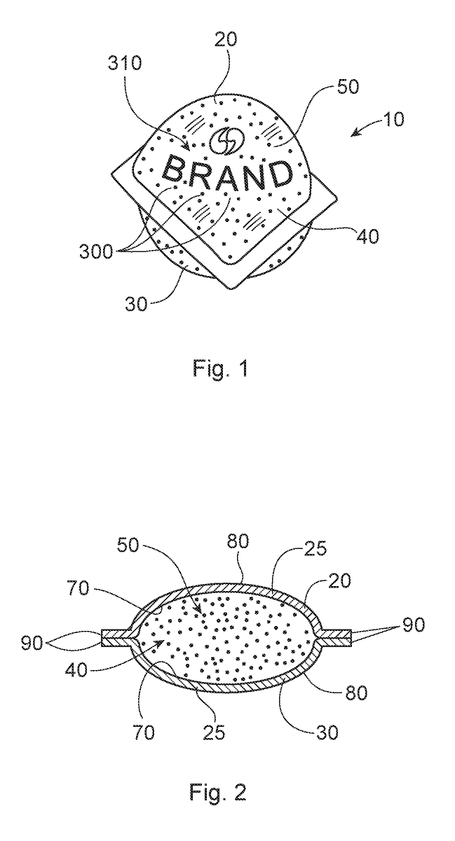

A water soluble pouch 10 is shown in FIG. 1. The water soluble pouch 10 can comprise a water soluble first sheet 20 and a water soluble second sheet 30 joined to the water soluble first sheet 20 to at least partially define a chamber 40 containing a substrate treatment agent 50. As shown in FIG. 1, the water soluble first sheet 20 can comprise a first plurality 310 of adjacent printed characters 300 each having a font size within about 15% of each member of the first plurality 310 of adjacent printed characters 300. As used herein, font size is measured in point where 1 point is equal to 0.3528 mm. The first plurality 310 can comprise three adjacent printed characters 300. The first plurality 310 can comprise three adjacent printed characters 300. The first plurality 310 can comprise five adjacent printed characters 300. The first plurality 310 of adjacent characters 300 can comprise a single line of text. The difference in the number of adjacent printed characters 300 is a way of considering the size of the zone in which distortion of the printing during manufacture is accounted for.

By adjacent printed characters 300, it is meant that there is an absence of characters between the characters referred to that have a font size outside of the range of font size referred to.

To provide for legible printing on a curved surface, it is thought to be desirable that adjacent printed characters 300 in a first plurality 310 of adjacent printed characters 300 should each have a font size within about 15% of each member of the plurality of characters.

In addition to the printed characters 300, the pouch 10 can have indicia indicating the number of pouches that can be used to wash a particularly sized load of laundry. For instance, the indicia can be a graphic of a single pouch for a small load, two pouches for a medium load, and three pouches for a large load. The small, medium, and large load can be designated by volume, for instance by the size or fullness of one or more indicia representative of a laundry basket or hamper or by the mass or weight of the load and the number of pouches required for adequate laundering.

Each of the first sheet 20 and second sheet 30 can have an interior surface 70 and an opposing exterior surface 80, as shown in FIG. 2. The interior surface 70 of the first sheet 20 and second sheet 30 can together form a chamber 40. The edges 90 of the first sheet 20 and second sheet 30 can be joined to one another to form the chamber 40. Within the chamber 40, the substrate treatment agent 50 can be disposed. At least one of the first sheet 20 and second sheet 30 can be a thermoformed sheet 25. The interior surface 70 of the first sheet 20 and second sheet 30 can be oriented towards the chamber 40.

The edges 90 can each have a length less than about 100 mm, or even less than about 60 mm, or even less than about 50 mm. The plan view of the of the water soluble pouch 10 can be substantially rectangular, substantially square, substantially circular, elliptical, superelliptical, or any other desired shape that is practical to manufacture. The overall plan area of the water soluble pouch can be less than about 10000 mm², or even less than about 2500 mm². Sized and dimensioned as such, the water soluble pouch 10 can fit conveniently within the grasp of an adult human hand. Further, for water soluble pouches 10 intended for use in automatic dishwashing machines, such a size can conveniently fit in the detergent receptacle within the machine.

The edges 90 of the first sheet 20 and second sheet 30 can be bonded to one another. For example, the edges 90 of the first sheet 20 and second sheet 30 can be joined to one another by a thermal bond or a solvent weld or combination thereof. A thermal bond can be formed by applying one or more of heat and pressure to the two materials to be bonded to one another. A solvent weld can be formed by applying a solvent to one or both of the first sheet and second sheet and contacting the first sheet and second sheet in the location at which a bond is desired. For water soluble pouches, the solvent can be water and or steam.

The first sheet 20 and the second sheet 30 can be sufficiently translucent, or even transparent, such that the substrate treatment agent 50 is visible from the exterior of the pouch 10. That is, the consumer using the pouch 10 can see the substrate treatment agent 50 contained in the pouch 10.

The pouch 10 can have a plurality of chambers 40. For example a plurality of pouches 10 can be joined to one another to for a multi-compartment pouch. One or more pouches of the kind illustrated in FIG. 2 can be joined to one another. The pouch 10 can be of the type presently marketed as TIDE PODS, CASCADE ACTION PACS, CASCADE PLATINUM, CASCADE COMPLETE, ARIEL 3 IN 1 PODS, TIDE BOOST ORIGINAL DUO PACs, TIDE BOOST FEBREZE SPORT DUO PACS, TIDE BOOST FEE DUO PACS, TIDE BOOSE VIVID WHITE BRIGHT PACS, DASH, FAIRY (PLATINUM, ALL-IN ONE, YES (PLATINUM ALL-IN ONE, JAR (PLATINUM, ALL-IN ONE, DREFT (PLATINUM, ALL-IN ONE by The Procter & Gamble Company in various geographies globally. The pouch 10 can have 3 chambers 40. The first sheet 20 and second sheet 30 can form a first chamber 40. Another first sheet 20 and second sheet 30 can form a second chamber 40 or one or more additional chambers 40. The two pouches 10 can be joined together. The chambers 40 can be superimposed upon one another. The chambers 40 can be a in a side by side relationship.

The pouch 10 can be sized and dimensioned to fit in an adult human hand. The pouch 10 can have a volume less than about 70 mL. The pouch 10 can have a volume less than about 50 mL. The pouch 10 can have a volume less than about 40 mL. The edges 90 can have a length between about 10 mm and about 70 mm. The edges 90 can have a length between about 20 mm and about 60 mm. The edges 90 can have a length between about 25 mm and about 50 mm.

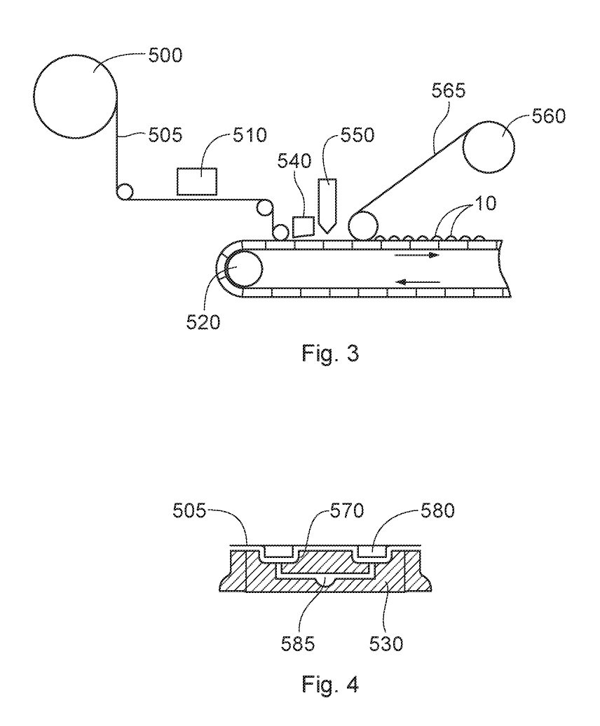

An apparatus for forming a water soluble pouch 10 is shown in FIG. 3. The apparatus can comprise a first web feed roll 500, a printing unit 510, a conveyor system 520, a plurality of molds 530 movably mounted on the conveyor system 520, an optional heater 540, a dispenser 550, and a second web feed roll 560. The first web 505 can be fed through the printing unit 510. The printing unit 510 can print the first plurality 310 of adjacent printed characters 300 onto the first web. The first web 505 can then be fed onto the conveyor system 520.

The printing unit 510 can be located between the first web feed roll 500 and the conveyor system 520. Optionally the printing unit 510 can be located between the second web feed roll 560 and the conveyor system 520. Optionally, the web feed roll 500 can be a pre-printed web feed roll having the first plurality 310 of adjacent printed characters 300 disposed thereon and the printing unit 510 can be eliminated. Further optionally, the web feed roll 560 can be a pre-printed web feed roll having the first plurality 310 of adjacent printed characters 300 disposed thereon and the printing unit 510 can be eliminated. The sheet forming the pouch 10 that has the first plurality 310 of adjacent printed characters 300 is considered to be the first sheet 20. The first sheet 20 can be from either the first web 505 or the second web 565. Similarly, the second sheet 30 can be from either the first web 505 or the second web 565.

Once on the conveyor system 520, the first web 505 can be plastically deformed in cups 570 in the mold 530, as shown in FIG. 4. The plastic deformation can be provided by thermoforming, thermoforming being considered to be a subset of plastic deformation. The first web 505 can be heated and drawn in to cups 570 in the mold 530, as shown in FIG. 4. The first web 505, heated or unheated above ambient temperature, can be drawn in by a vacuum applied to the face of the cups 570 via a vacuum transmission system 585. The molded first web 505 can then be filled or partially filled with the substrate treatment agent 50 by the dispenser 550. The second web 565 is then brought into facing relationship with the molded first web 505 and sealed to the first web 505 to form a pouch 10. With the addition of heat, the plastic deformation described herein can be thermoforming

Any suitable process of sealing the first web 505 and the second web 565 may be used. The sealing may occur in the landing areas between individual cups 570 of the molds 530. Non-limiting examples of such means include heat sealing, solvent welding, solvent or wet sealing, and combinations thereof. Heat and or solvent can be applied to the entire surface of the sheet or only the area which is to form the seal is treated with heat or solvent. The heat or solvent can be applied by any process, typically on the closing material, and typically only on the areas which are to form the seal. If solvent or wet sealing or welding is used, heat can also be applied. Wet or solvent sealing/welding processes include selectively applying solvent onto the area between the molds, or on the closing material, by for example, spraying or printing this onto these areas, and then applying pressure onto these areas, to form the seal. Sealing rolls and belts as described above that optionally also provide heat can be used, for example.

A cutting operation can be integral with or located down-stream of the apparatus shown in FIG. 3 to separate the pouches 10 into individual pouches 10. The formed pouches 10 may then be cut by a cutting device. Cutting can be accomplished using any known process. The cutting can be done in continuous manner, optionally with constant speed and in a horizontal position. The cutting device can, for example, be a sharp item or a hot item, whereby in the latter case, the hot item ‘burns’ through the sheet/sealing area.

From the viewpoint of an individual pouch 10, the process for making the water soluble pouch 10 is a multi-step process. Distortion printing of a first plurality 310 of adjacent printed characters 300 on a water soluble first sheet 20 is performed. A water soluble second sheet 30 is provided. A compartment 580 is then formed in one of the first sheet 20 and the second sheet 30 by plastically deforming such sheet. A substrate treatment agent 50 is placed in the compartment 580. And, the first sheet 20 and the second sheet 30 are sealed to one another to form an enclosed pouch 10.

In the process of making the pouch 10, at least one of the first sheet 20 and the second sheet 30 is plastically deformed. Optionally, at least one of the first sheet 20 and the second sheet 30 is thermoformed. Depending on the properties of the sheets forming the pouch 10, the sheet that is plastically deformed to form the compartment 580 into which the substrate treatment agent 50 is placed may partially rebound after the sheet is joined to the other sheet. Depending on the properties of the first sheet 20 and the second sheet 30, the pouch 10 can be designed to have more or less curved sheets.

When forming the pouches 10 as described herein, the sheet that is deformed to make the compartment 580 may rebound after the other sheet is joined thereto and the pouch 10 is formed. As the rebounding sheet contracts, the other sheet may be plastically deformed by the increase in pressure within the chamber 40 arising due to the contracting sheet. Thus, it is possible that even though only one sheet is deformed to make the compartment 580, both sheets may be plastically deformed when the sheet initially drawn in to the cup 570 rebounds. As such, the first web 505 and or the second web 565 can comprise the first sheet 20 that is distortion printed. Heat can optionally be applied to the sheet that was not plastically deformed into the cup 570 such that plastic deformation of the other sheet can be by thermoforming as well as by way of the rebounding of the one sheet driving deformation of the other sheet.

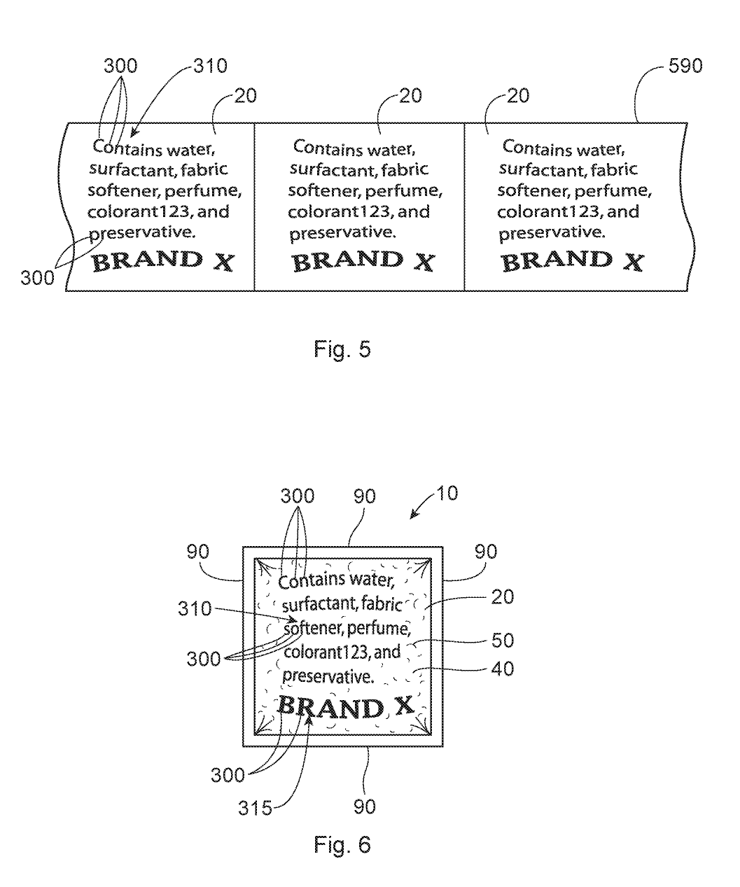

A web 590 that can be the first web 505 and or second web 565 is shown in FIG. 5. As shown in FIG. 5, the web 590 can be formed by distortion printing a first plurality 310 of adjacent printed characters 300 on the water soluble first sheets 20 that make up the web 590. As shown in FIG. 5, the adjacent printed characters 300 are distorted relative to one another. In general the amount of distortion in the adjacent printed characters 300 is a function of the amount of deformation that will occur at a particular location when the first sheet 20 is deformed to make a pouch 10. The strain arises as a result of the flat sheet being transformed into a three-dimensional shape.

When the first sheet 20 is deformed to make the pouch 10, the first sheet 20 will be deformed into a three-dimensional shape. The amount of deformation in the first sheet 20 may vary locally. Such variability in local deformation might arise as a result of the particular geometry of the pouch 10, the shape, pressure, and temperature of the mold 530 if the first sheet 20 is drawn into the mold 530, and the particular recovery characteristics of one or both of the first sheet 20 and second sheet 30 after being plastically deformed or being plastically deformed by thermoforming.

If the first plurality 310 of adjacent printed characters 300 were not distortion printed and the adjacent printed characters had a uniform font size, when the first sheet 20 is transformed into a three dimensional shape the first plurality 310 of adjacent printed characters 300 would end up having a non-uniform font size and may become illegible. By distortion printing the first sheets 20, the first plurality 310 of adjacent printed characters 300 on the finished pouch may have a substantially uniform font size, by way of non-limiting example as shown in FIG. 6. FIG. 6 is a top view of a pouch 10. The first plurality 310 of adjacent printed characters 300 on the finished pouch 10 can each have a font size within about 15% of each member of the first plurality 300 of adjacent printed characters 300. The first plurality 310 of adjacent printed characters 300 on the finished pouch 10 can each have a font size within about 10% of each member of the first plurality 300 of adjacent printed characters 300. The first plurality 310 of adjacent printed characters 300 on the finished pouch 10 can each have a font size within about 5% of each member of the first plurality 300 of adjacent printed characters 300.

The first plurality 310 of adjacent printed characters 300 can be printed on the interior surface 70 of one of the first sheet 20 and second sheet 30. By providing the adjacent printed characters 300 on the interior surface 70 of one of the first sheet 20 and second sheet 30, the printing is protected from abrasion with the manufacturing equipment during manufacture of the pouch 10 and during handling of the pouch 10 during packaging, extraction of the pouch 10 from a container, and handling by the consumer's hand as she transfers the pouch 10 from a storage container into the device it will be used with. Further, printing provided as such is also protected from wetting by the consumer's hand as she handles the pouch 10. Further, printing provided as such is also protected from the printing being marred in the event that pouches 10 stored in a container stick together in some manner. Unlike other applications in which printing is on the exterior of the printed object or a sleeve stretched or shrunk onto the object, in the present application the printing can be on the interior of the object to obtain a number of the aforesaid benefits.

As shown in FIG. 6, the pouch 10 can be a pouch 10 wherein the first sheet 20 comprises a second plurality 315 of adjacent printed characters 300 each having a font size within about 15% of each member of the second plurality 315 of the adjacent printed characters 300, wherein the first plurality 310 has a first average font size and the second plurality 315 has a second average font size that differs by more than about 15% from the first average font size. The first plurality 315 of adjacent printed characters 300 can comprise a single line of text, by way of non-limiting example as shown in FIG. 6 a single line of text such as “softener, perfume.” Similarly, the second plurality 315 of adjacent printed characters 300 can comprise a single line of text, by way of non-limiting example as shown in FIG. 6 in the words “BRAND X.”

The ink used to print the first plurality 310 of adjacent printed characters 300 and second plurality 315 of adjacent printed characters 300 can be printed on the first sheet 20 and or second sheet 30 using any of the known techniques for printing on thin water soluble substrates. The ink used to print the first plurality 310 of adjacent printed characters 300 and second plurality 315 can be printed using any processes known in the art including but not limited to gravure printing, flexographic printing, and offset printing, letter press, lithography, plateless, post press, and screen printing. Gravure printing is the direct transfer of liquid ink to substrate from a metal image carrier. The image is lower than the surface of the image carrier base. Flexography printing is the direct transfer of liquid ink to substrate from a photopolymer image carrier. The image is raised above the surface of the image carrier base. Offset printing is the indirect transfer of paste ink to substrate from a rubber ‘blanket’ that is intermediate to substrate and the thin metal image carrier. Examples of plateless printing include electronic printing, ink jet printing, magnetography, ion deposition printing, direct charge deposition printing, and the Mead Cycolor Photocapsule process.

The ink can comprise AQUADESTRUCT black. The ink can comprise AQUADESTRUCT white. AQUADESTRUCT inks are available from Sun Chemical, Parsippany, N.J., United States of America. The ink can comprise pigment white 6 (titanium dioxide). The ink can comprise pigment black 7 (carbon). The ink can comprise pigment black 6. The ink can comprise pigment black 8. The ink can comprise pigment white 6. Any one or more than one of the inks disclosed herein, including AQUADESTRUCT black, AQUADESTRUCT white may be located on an interior surface 70 or exterior surface 80 of one or both of the first sheet 20 and second sheet 30. The ink can be covered by one or more protective layers. The ink can comprise pigment, water, binder, bactericide, and solvent. The ink can be water soluble.

The ink can comprise from about 1% by weight to about 50% by weight a pigment. The ink can comprise from about 3% by weight to about 40% by weight a pigment. The ink can comprise from about 5% by weight to about 35% by weight a pigment. The ink can comprise from about 7% by weight to about 25% by weight a pigment. The ink can comprise from about 9% by weight to about 20% by weight a pigment. The pigment can be selected from the group consisting of titanium oxide, lampblack, pigment red 254, and combinations thereof.

The ink can comprise a polyvinyl alcohol binder. The ink can comprise about 1% to about 20% by weight of polyvinyl alcohol binder. The ink can comprise about 5% to about 15% by weight of polyvinyl alcohol binder. The ink can comprise about 8% to about 12% by weight of polyvinyl alcohol binder.

The ink can partially absorb into the sheet upon which it is printed and partially dry on the surface. The absorption and drying can take between about 0.1 and about 5 seconds, or even from about 1 to about 3 seconds. The amount of ink printed onto the water-soluble film can affect the absorption and drying rate. The ink can be applied at a weight from about 0.1 to about 30 g/m² of sheet, or even from about 0.5 to about 18 g/m² of sheet, or even from about 1 to about 10 g/m² of sheet to obtain good printing quality. From about 1% to about 100%, or even about 10% to about 40%, of one or both of the interior surface 70 and exterior surface 80 can be printed upon. When printed upon the sheet, the ink can partially dissolve the sheet and be absorbed into the sheet.

The first plurality 310 of adjacent printed characters 300 can constitute instructions for using the pouch 10. The instructions can be printed on one or both of the interior surface 70 and exterior surface 80 of one or both of the first sheet 20 and second sheet 30. The instructions may provide directions on the temperature of the wash cycle to be used, the duration of the wash cycle to be used, what type of substrates may be treated with the substrate treatment agent 50, the recommendation to avoid premature wetting of the pouch 10, what type of appliance within which the pouch 10 should not be used, product manufacture/expiration date, ingredient list, contact information for the manufacturer, recommended storage conditions, and the like. Providing the instructions integral with the pouch 10 so that they are apparent to the consumer at the time of use can make the pouch 10 easier to use by the consumer.

The substrate treatment agent 50 can be a liquid, but may be a solid or tablet. By the term ‘liquid’ it is meant to include liquid, paste, waxy or gel compositions. A liquid substrate treatment agent 50 may comprise a solid. Solids may include powder or agglomerates, such as micro-capsules, beads, noodles or one or more pearlised balls or mixtures thereof. Such a solid element may provide a technical benefit, through the wash or as a pre-treat, delayed or sequential release component. Alternatively it may provide an aesthetic effect. The substrate treatment agents 50 of the present invention may comprise one or more of the ingredients discussed below.

The substrate treatment agent 50 of the present invention can comprise a surfactant. The total surfactant level may be in the range of from about 1% to about 80% by weight of the substrate treatment agent 50. The substrate treatment agent 50 can comprise linear alkylbenzene sulfonates and or alcoholethoxy sulfate and or C12-16 Pareth-9 and or fatty acid salts and or enzyme and or sodium carbonate and or sodium percarbonate and or methyl glycine diacetic acid, trisodium salt and or alcohol alkoxylate.

The substrate treatment agent 50 can be selected from the group consisting of liquid laundry detergent, a powdered laundry detergent, a liquid dishwashing detergent, a powder dishwashing detergent, a liquid bleaching agent, a powdered bleaching agent, a liquid fabric softener, a powdered fabric softener, a liquid laundry scent additive, a powder laundry scent additive, a liquid fabric care benefit agent, and a solid fabric care benefit agent. The substrate treatment agent 50 can be a fabric softener comprising a quaternary ammonium salt and or a dehydrogenated tallow dimethyl ammonium chloride and or a diethyl ester dimethyl ammonium chloride. A substrate treatment agent 50 can be formulated to treat a substrate selected from the group consisting of glassware, dishware, flooring, textiles, tires, automobile bodies, teeth, dentures, skin, fingernails, toenails, hair, appliance surfaces, appliance interiors, toilets, bathtubs, showers, mirrors, deck materials, windows, and the like.

The first sheet 20 and second sheet 30 can be a water soluble material. The water soluble material can be a polymeric material that can be formed into a sheet or film. The sheet material can, for example, be obtained by casting, blow-molding, extrusion or blown extrusion of the polymeric material, as known in the art.

The first sheet 20 and second sheet 30 can have a thickness of from about 20 to about 150 micron, or even about 35 to about 125 micron, or even about 50 to about 110 micron, or even about 76 micron.

The first sheet 20 and second sheet 30 can have a water-solubility of at least 50%, or even at least 75%, or even at least 95%, as measured by the method set out hereafter using a glass-filter with a maximum pore size of 20 microns: 50 grams±0.1 gram of sheet material is added in a pre-weighed 400 ml beaker and 245 ml±1 ml of distilled water is added. This is stirred vigorously on a magnetic stirrer, labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Suitable polymers, copolymers or derivatives thereof suitable for use as pouch material can be selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. Suitable polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and suitably selected from polyvinyl alcohols, polyvinyl alcohol copolymers and hydroxypropyl methyl cellulose (HPMC), and combinations thereof. The level of polymer in the sheet material, for example a PVA polymer, can be at least 60%. The polymer can have any weight average molecular weight, such as from about 1000 to about 1,000,000, or even from about 10,000 to about 300,000, or even from about 20,000 to about 150,000.

Mixtures of polymers can also be used as the sheet material. This can be beneficial to control the mechanical and/or dissolution properties of the compartments or sheet, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000 to about 40,000, or even about 20,000, and of PVA or copolymer thereof, with a weight average molecular weight of about 100,000 to about 300,000, or even about150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1 to about 35% by weight polylactide and about 65% to about 99% by weight polyvinyl alcohol. Suitable for use herein are polymers which are from about 60% to about 98% hydrolysed, or even about 80% to about 90% hydrolysed, to improve the dissolution characteristics of the material.

Suitable sheets can exhibit good dissolution in cold water, meaning unheated distilled water. Such films can exhibit good dissolution at a temperature of about 24° C., or even about 10° C. By good dissolution it is meant that the sheet exhibits water-solubility of at least about 50%, or even at least about 75%, or even at least about 95%, as measured by the method set out herein and described above.

Suitable sheets can be those supplied by Monosol under the trade references M8630, M8900,

M8779, M8310, films described in U.S. Pat. No. 6,166,117 and U.S. Pat. No. 6,787,512 and PVA films of corresponding solubility and deformability characteristics. Further suitable sheets can be those described in US2006/0213801, WO 2010/119022 and U.S. Pat. No. 6,787,512.

Suitable sheets can be those resins comprising one or more PVA polymers. The water soluble sheet resin can comprise a blend of PVA polymers. For example, the PVA resin can include at least two PVA polymers, wherein as used herein the first PVA polymer has a viscosity less than the second PVA polymer. A first PVA polymer can have a viscosity of at least 8 centipoise (cP), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in cP should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons.

The PVA resin can still further include one or more additional PVA polymers that have a viscosity in a range of about 10 to about 40 cP and a degree of hydrolysis in a range of about 84% to about 92%.

When the PVA resin includes a first PVA polymer having an average viscosity less than about 11 cP and a polydispersity index in a range of about 1.8 to about 2.3, then in one type of embodiment the PVA resin contains less than about 30 wt % of the first PVA polymer. Similarly, when the PVA resin includes a first PVA polymer having an average viscosity less than about 11 cP and a polydispersity index in a range of about 1.8 to about 2.3, then in another, non-exclusive type of embodiment the PVA resin contains less than about 30 wt % of a PVA polymer having a Mw less than about 70,000 Daltons.

Of the total PVA resin content in the film described herein, the PVA resin can comprise about 30 to about 85 wt. % of the first PVA polymer, or about 45 to about 55 wt. % of the first PVA polymer. For example, the PVA resin can contain about 50 wt. % of each PVA polymer, wherein the viscosity of the first PVA polymer is about 13 cP and the viscosity of the second PVA polymer is about 23 cP.

One type of embodiment is characterized by the PVA resin including about 40 to about 85 wt % of a first PVA polymer that has a viscosity in a range of about 10 to about 15 cP and a degree of hydrolysis in a range of about 84% to about 92%. Another type of embodiment is characterized by the PVA resin including about 45 to about 55 wt % of the first PVA polymer that has a viscosity in a range of about 10 to about 15 cP and a degree of hydrolysis in a range of about 84% to about 92%. The PVA resin can include about 15 to about 60 wt % of the second PVA polymer that has a viscosity in a range of about 20 to about 25 cP and a degree of hydrolysis in a range of about 84% to about 92%. One contemplated class of embodiments is characterized by the PVA resin including about 45 to about 55 wt % of the second PVA polymer.

When the PVA resin includes a plurality of PVA polymers the PDI value of the PVA resin is greater than the PDI value of any individual, included PVA polymer. Optionally, the PDI value of the PVA resin is greater than 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, or 5.0.

The PVA resin can have a weighted, average degree of hydrolysis (H̅°̅) between about 80 and about 92%, or between about 83 and about 90%, or about 85 and 89%. For example, H̅°̅ for a PVA resin that comprises two or more PVA polymers is calculated by the formula H̅°̅=Σ(Wi·Hᵢ) where Wᵢ is the weight percentage of the respective PVA polymer and a Hᵢ is the respective degrees of hydrolysis. Still further it can be desirable to choose a PVA resin that has a weighted log viscosity (μ̅) between about 10 and about 25, or between about 12 and 22, or between about 13.5 and about 20. The μ̅ for a PVA resin that comprises two or more PVA polymers is calculated by the formula μ̅=e^{ΣW}^{ᵢ}^{·1nμ}^{ᵢ} where μᵢ is the viscosity for the respective PVA polymers.

Yet further, it can be desirable to choose a PVA resin that has a Resin Selection Index (RSI) in a range of about 0.255 to about 0.315, or about 0.260 to about 0.310, or about 0.265 to about 0.305, or about 0.270 to about 0.300, or about 0.275 to about 0.295, or about 0.270 to about 0.300. The RSI is calculated by the formula; Σ(Wᵢ|μᵢ−μᵢ|)/Σ(Wᵢμᵢ), wherein μᵢ is seventeen, μᵢ is the average viscosity each of the respective PVOH polymers, and Wᵢ is the weight percentage of the respective PVOH polymers.

Also suitable are water soluble sheets comprising a least one negatively modified monomer with the following formula:

[Y]−[G]ₙ

wherein Y represents a vinyl alcohol monomer and G represents a monomer comprising an anionic group and the index n is an integer of from 1 to 3. G can be any suitable comonomer capable of carrying of carrying the anionic group, optionally G is a carboxylic acid. G can be selected from the group consisting of maleic acid, itaconic acid, coAMPS, acrylic acid, vinyl acetic acid, vinyl sulfonic acid, allyl sulfonic acid, ethylene sulfonic acid, 2 acrylamido 1 methyl propane sulfonic acid, 2 acrylamido 2 methyl propane sulfonic acid, 2 methyl acrylamido 2 methyl propane sulfonic acid and mixtures thereof.

The anionic group of G can be selected from the group consisting of OSO₃M, SO₃M, CO₂M, OCO₂M, OPO₃M₂, OPO₃HM and OPO₂M. Suitably, the anionic group of G can be selected from the group consisting of OSO₃M, SO₃M, CO₂M, and OCO₂M. Suitably, the anionic group of G can be selected from the group consisting of SO₃M and CO₂M.

Naturally, different sheet material and/or sheets of different thickness may be employed in making the compartments of the present invention. A benefit in selecting different films is that the resulting compartments may exhibit different solubility or release characteristics.

The sheet material herein can also comprise one or more additive ingredients. For example, it can be beneficial to add plasticizers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of making a water soluble pouch comprising the steps of:
distortion printing a first plurality of adjacent printed characters on a water soluble first sheet;
providing a water soluble second sheet;
forming a compartment in one of said first sheet and said second sheet by plastic deformation;
placing a substrate treatment agent in said compartment; and
sealing said first sheet and said second sheet to one another to form a chamber.

2. The process of making a water soluble pouch according to claim 1, wherein said plastic deformation is by thermoforming.

3. The process of making a water soluble pouch according to claim 1, wherein said compartment is formed in said first sheet.

4. The process of making a water soluble pouch according to claim 3, wherein each of said first sheet and said second sheet have an interior surface and an opposing exterior surface wherein said chamber is at least partially defined by said interior surface of said first sheet and said interior surface of said second sheet, wherein said first plurality of adjacent printed characters is on said interior surface of said first sheet.

5. The process of making a water soluble pouch according to claim 1, wherein said compartment is formed in said second sheet.

6. The process of making a water soluble pouch according to claim 1, wherein said substrate treatment agent is a powder or liquid.

7. The process of making a water soluble pouch according to claim 1, wherein said first plurality of adjacent printed characters comprises three printed characters, wherein said characters of said first plurality of adjacent printed characters each have a font size within about 10% of each member of said first plurality of adjacent printed characters.
